(19) United States
(12) Patent Application Publication
(10) Pub. No.: US 2012/0318387 A1
(43) Pub. Date: Dec. 20, 2012

(54) FEMALE CONNECTOR FOR PIPES

(75) Inventor: WAN-PAO CHEN, Chang-Hua Hsien (TW)

(73) Assignee: HUI BAO ENTERPRISE CO., LTD., Chang-Hua Hsien (TW)

(21) Appl. No.: 13/451,408

(22) Filed: Apr. 19, 2012

(30) Foreign Application Priority Data
Jun. 20, 2011 (TW) 100211117

(51) Int. Cl. F16L 37/00

(52) U.S. Cl. 137/614

(57) ABSTRACT

A male connector includes a connecting member which has a cone-shaped exit defined therein and the connecting member is connected to a pipe connector to define a space therebetween. A movable member has a cone-shaped end and multiple openings are defined through the wall of the movable member. The movable member is movably located in the space and the cone-shaped end seals the cone-shaped exit of the connecting member along the direction of the fluid. The cone-shaped end has multiple grooves or release holes to slowly release the residual pressurized fluid of the pneumatic tool or the hydraulic tool so as to safely separate the male and female connectors and mitigate the noise.

### FIELD OF THE INVENTION

The present invention relates to a male connector, and more particularly, to a safety pressure releasing mechanism of a male connector for pneumatic or hydraulic piping systems.

### BACKGROUND OF THE INVENTION

The conventional connecting device 9 used for pneumatic or hydraulic piping systems generally comprises a female connector 91 and a male connector 92, wherein the female connector 91 has multiple beads 911 located at the inner periphery thereof and the male connector 92 has a groove 921 defined in the outside thereof. The male connector 92 is inserted into the female connector 91 and the beads 911 are engaged with the groove 921 to position the relative positions between the male and female connectors 92, 91. The connecting device 9 is widely used for the pneumatic tools or hydraulic tools. The pneumatic tools are powered by the pressurized air wherein the male connector 92 is located at the inlet of the pneumatic tool and the female connector 91 is connected to the hose 93 connected with the air compressor. When the female connector 91 is not yet connected with the male connector 92, there is a valve in the female connector 91 to seal the female connector 91 so that the pressurized air cannot not released from the female connector 91. When the female connector 91 is connected with the male connector 92, the male connector 92 pushes the valve so that the pressurized air is introduced into the pneumatic tool via the valve and the male connector 92. The male connector 92 is positioned by the engagement between the beads 911 and the groove 921.

However, because the air compressor continuously provides the pressurized air, so that when separating the male connector 92 from the female connector 91, the pressure in the hose will accelerate the male connector 92 to be separated from the female connector 91, and the hose 93 swings randomly and quickly. The female connector 91 on the hose 93 may hit the users and the release of the pressure from the male connector 92 generates noise which may damage the hearing function of the users.

The present invention intends to provide a male connector which is able to release the pressure remained therein when the male connector is separated from the female connector.

### SUMMARY OF THE INVENTION

The present invention relates to a male connector and comprises a tubular connecting member which has a first connecting portion and a first connecting end respectively located on two ends thereof. The outer diameter of the first connection portion is larger than that of the first connecting end. The connecting member with the first connecting portion and the first connecting end are made integrally and form multiple radial sections. A cone-shaped exist is defined in the connecting member. A tubular pipe connector has a second connecting portion and a second connecting end located on two ends thereof. The outer diameter of the second connection portion is larger than that of the second connecting end. The pipe connector with the second connecting portion and the second connecting end are made integrally and form multiple radial sections. A hollow movable member has a cone-shaped end at the first end thereof. Multiple openings are defined through the wall of the movable member. The movable member is movably located in the space formed between the connecting member and the pipe connector. The cone-shaped end seals the cone-shaped exit of the connecting member.

Preferably, the cone-shaped end of the movable member has multiple grooves defined in the outer surface thereof.

Preferably, the cone-shaped end of the movable member has multiple grooves defined axially in the outer surface thereof.

The present invention has the movable member movably located in the male connector so as to seal the cone-shaped exit to prevent the residual pressure from ejecting from the male connector when the male connector is separated from the female connector. The movable member allows the pressurized fluid to slowly exit from the male connector to reduce noise.

The present invention is composed of a connecting member, a pipe connector, a movable member and a seal ring, the assembling is easy.

The travelling end of the movable member is movable in the travelling passage at low friction so that the movable member is moved to seal the cone-shaped exit eventually and the pressurized fluid can slowly exit from the male connector.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows that the male connector or the present invention is cooperated with a pneumatic tool;

FIG. 2 is an exploded view to show the male connector of the present invention;

FIG. 3 is a cross sectional view to show that the fluid enters into the male connector of the present invention;

FIG. 4 is a cross sectional view to show that the fluid is released from the male connector of the present invention;

FIG. 5 is an exploded view to show another embodiment of the male connector of the present invention;

FIG. 6 is a cross sectional view to show that the fluid is released from the male connector disclosed in FIG. 5;

FIG. 7 is a cross sectional view to show yet another embodiment of the male connector of the present invention, wherein the fluid is released from the male connector;

FIG. 8 is a perspective view to show the conventional female connector and the conventional male connector, and

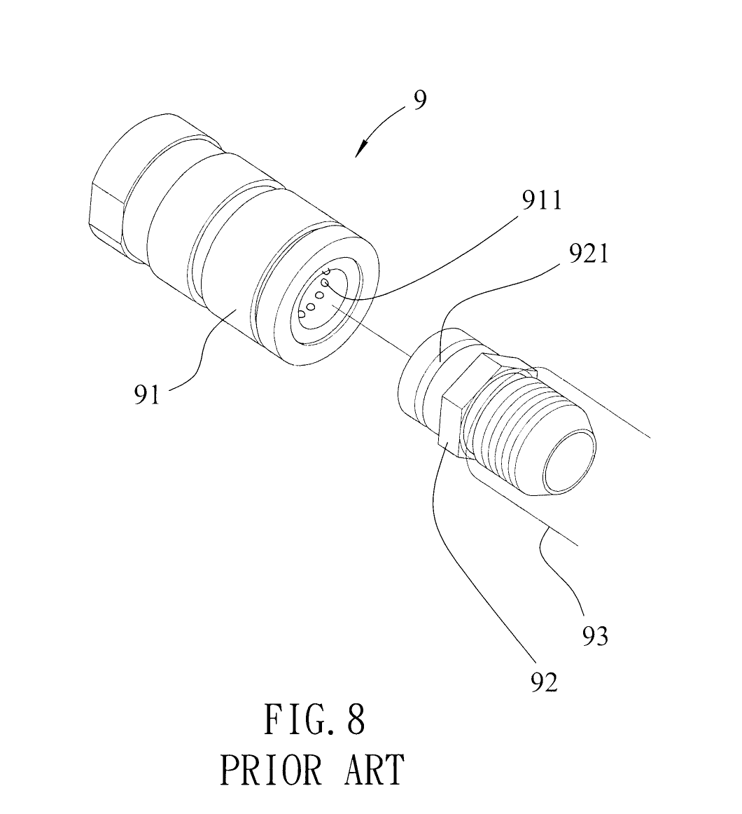

FIG. 9 is a cross sectional view of the conventional male connector.

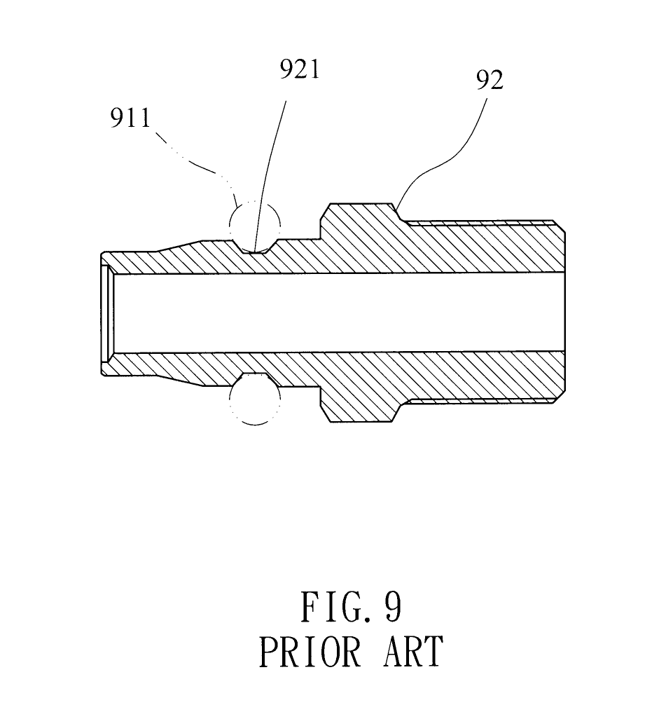

### DETAILED DESCRIPTION OF THE PREFERRED EMBODIMENT

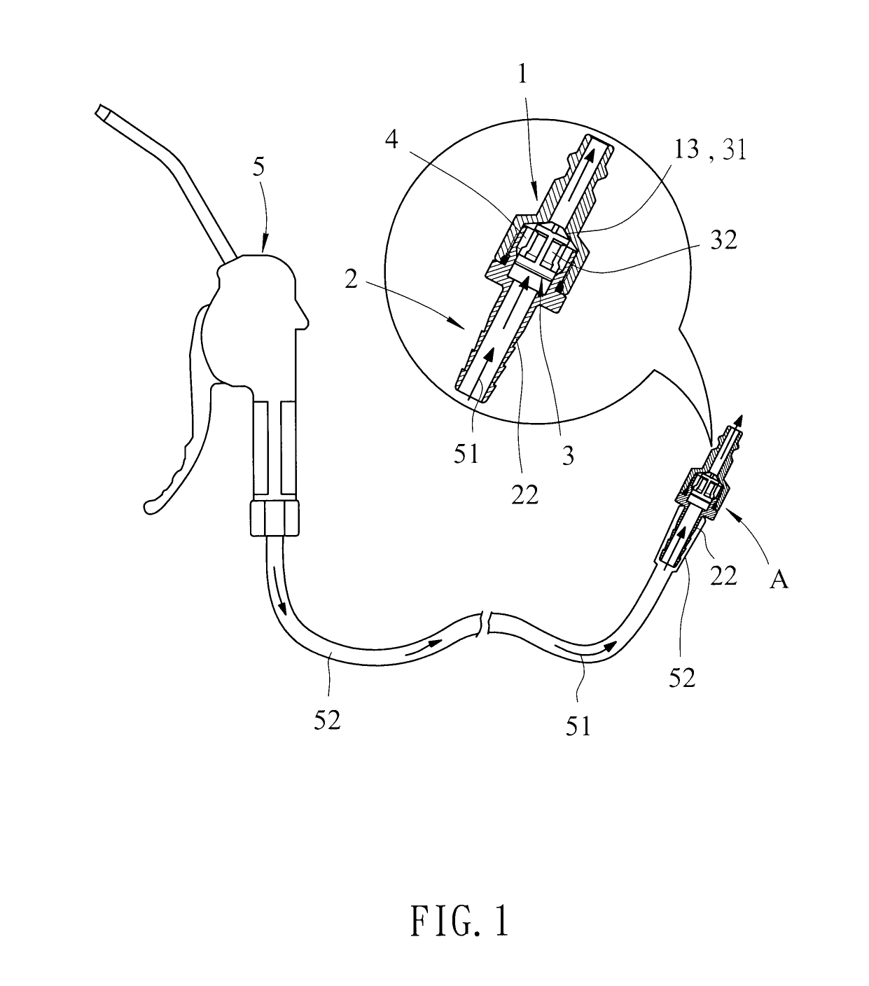

Referring to FIGS. 1 to 3, the male connector of the present invention comprises a connecting member 1, a pipe connector 2 and a movable member 3.

The connecting member 1 is a tubular member and has a first connecting portion 11, a first hexagonal portion 14 and a first connecting end 12, wherein the first connecting portion 11 and the first connecting end 12 are respectively located on two ends of the connecting member 1. The outer diameter of the first connection portion 11 is larger than that of the first connecting end 12, and smaller than that of the first hexagonal portion 14. The connecting member 1 with the first connecting portion 11, the first hexagonal portion 14 and the first connecting end 12 are made integrally and form multiple radial sections. The first connecting portion 11 has inner threads 111 and a cone-shaped exist 13 is defined in the connecting member 1.

The pipe connector 2 is a tubular member and comprises a second connecting portion 21, a second hexagonal portion 23 and a second connecting end 22, wherein the second connecting portion 21 and the second connecting end 22 are located on two ends of the pipe connector 2. The outer diameter of the second connection portion 21 is larger than that of the second connecting end 22, and smaller than that of the second hexagonal portion 23. The pipe connector 2 with the second connecting portion 21, the second hexagonal portion 23 and the second connecting end 22 are made integrally and form multiple radial sections. The second connecting portion 21 has outer threads 211.

The movable member 3 is a hollow member and has a cone-shaped end 31 at the first end thereof. Multiple openings 32 are defined through the wall of the movable member 3, preferably, there are four openings 32. The movable member 3 is movably located in a space 4 which is formed between the connecting member 1 and the pipe connector 2, when the connecting member 1 is connected to the pipe connector 2. The cone-shaped end 31 seals the cone-shaped exit 13 of the connecting member 1 when the movable member 3 moves along the direction that the pressurized fluid 51 moves. The movable member 3 has a travelling end 313 at the second end thereof, wherein the outer diameter of the travelling end 313 is larger than the outer diameter of the movable member 3 so as to form a stepped portion. The length of the travelling end 313 is one third of the length of the movable member 3. The outer diameter “D” of the travelling end 313 is larger than the outer diameter “d” of the movable member 3. The length “L2” of the movable member 3 is longer than the length “L1” from the cone-shaped exit 13 to an entrance of the travelling passage 41, and shorter than the length “L” of the space 4. A travelling passage 41 is defined between the connecting member 1 and the pipe connector 2, and the travelling passage 41 communicates with the space 4. The travelling end 313 is movable in the travelling passage 41. The cone-shaped end 31 of the movable member 3 has multiple grooves 311 defined in the outer surface thereof.

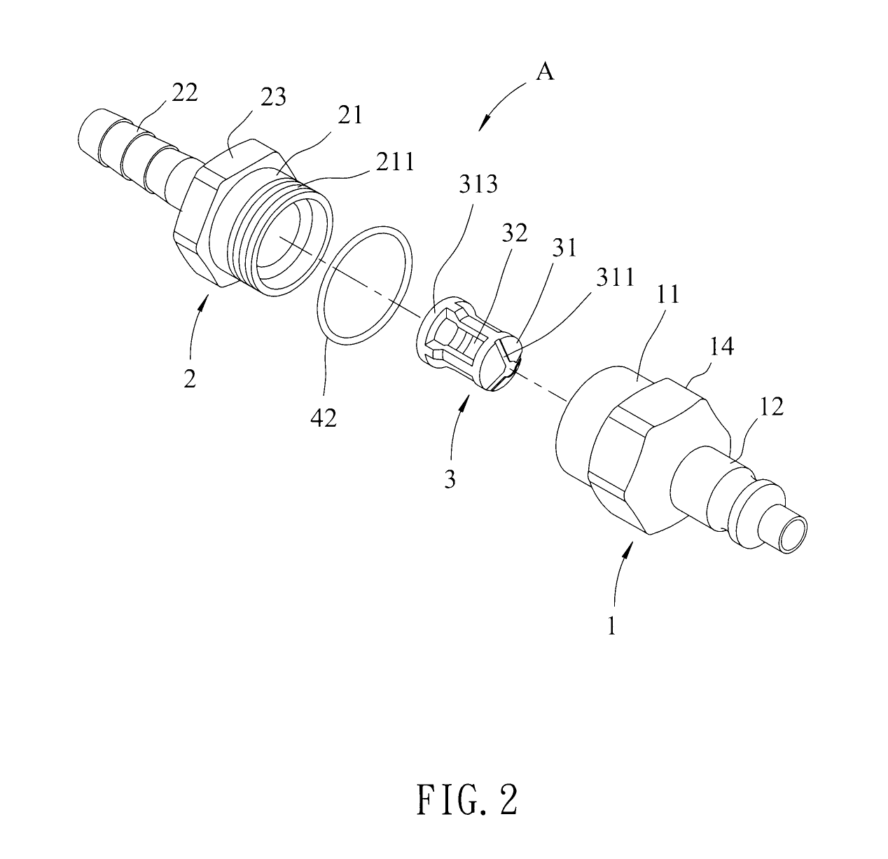

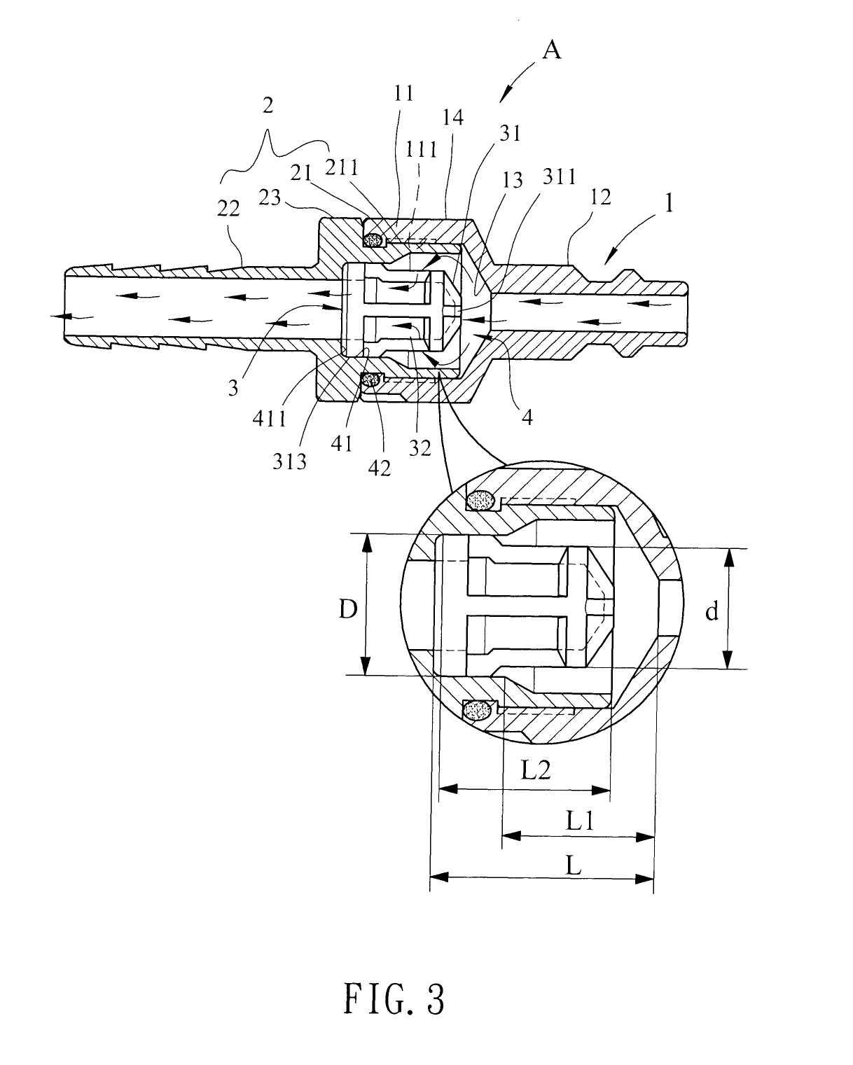

As shown in FIGS. 2 and 3, the pipe connector 2, the seal ring 42, the movable member 3 and the connecting member 1 are assembled in sequence, wherein the outer threads 211 of the pipe connector 2 are connected with the inner threads 111 of the connecting member 1, by using two wrenches, the connecting member 1 and the pipe connector 2 are connected to each other. The seal ring 42 is secured to prevent leakage of the male connector “A”. A hose 52 is mounted to the second connecting end 22 of the male connector “A” and the other end of the hose 52 is connected to the pneumatic tool 5 or the hydraulic tool as shown in FIG. 1.

As shown in Fig, 3, the movable member 3 moves along the flowing of the pressurized fluid 51 in the space 4, the friction between the travelling end 313 and the travelling passage 41 is low so that the movable member smoothly moves with the flowing of the pressurized fluid 51 regardless of the volume of the pressurized fluid 51. When the male connector “A” is connected to the female connector which is connected with the source of pressure, the pressurized fluid 51 is introduced into the pneumatic tool 5 or the hydraulic tool. The travelling end 313 of the movable member 3 moves the inner end 411 of the travelling passage 41 of the space 4. Because of the openings 32, the pressurized fluid 51 successfully flows to the pneumatic tool 5 or the hydraulic tool and drives the pneumatic tool 5 or the hydraulic tool.

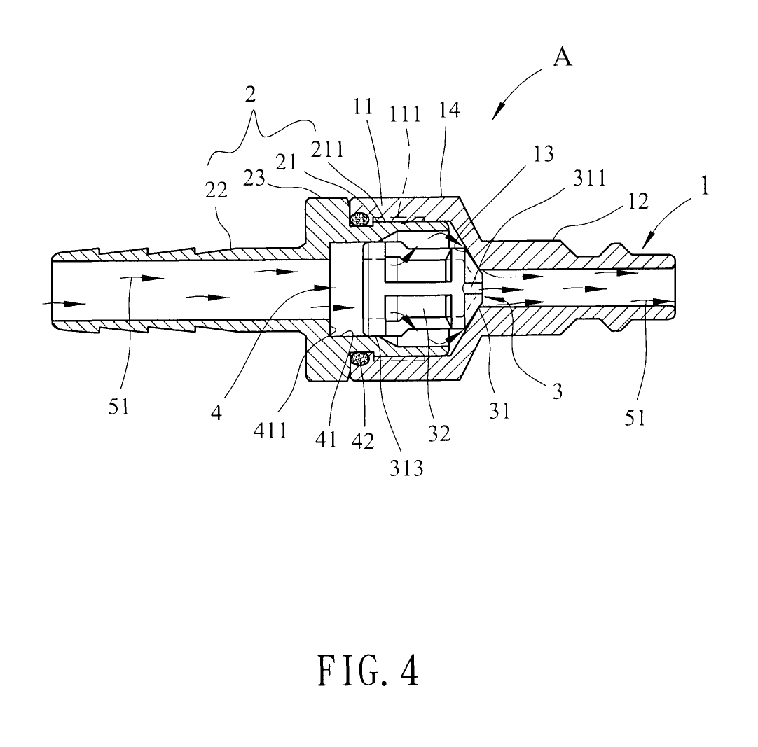

As shown in FIG. 4, when separating the male connector “A” from the female connector, the pressurized fluid 51 flows from the pneumatic tool 5 or the hydraulic tool toward the male connector “A”. The pressurized fluid 51 moves the movable member 3 and the travelling end 313 of the movable member 3 seals the cone-shaped exit 13 of the connecting member 1. Because of the grooves 311 defined in the cone-shaped end 31, the residual pressurized fluid 51 in the hose 52 is released from the grooves 311 and exits from the cone-shaped exit 13. In other words, when the cone-shaped end 31 is engaged with the cone-shaped exit 13, the residual pressurized fluid 51 in the hose 52 is released from the male connector “A” slowly. Therefore, the hose 52 does not swing randomly and the male connector “A” does not hurt the users.

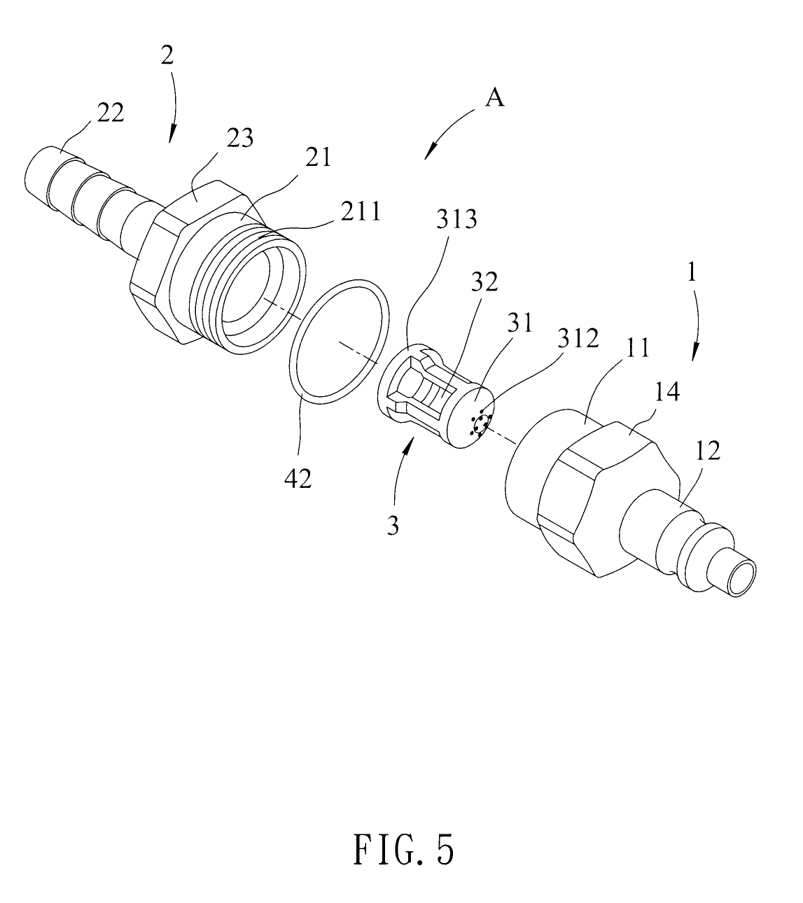

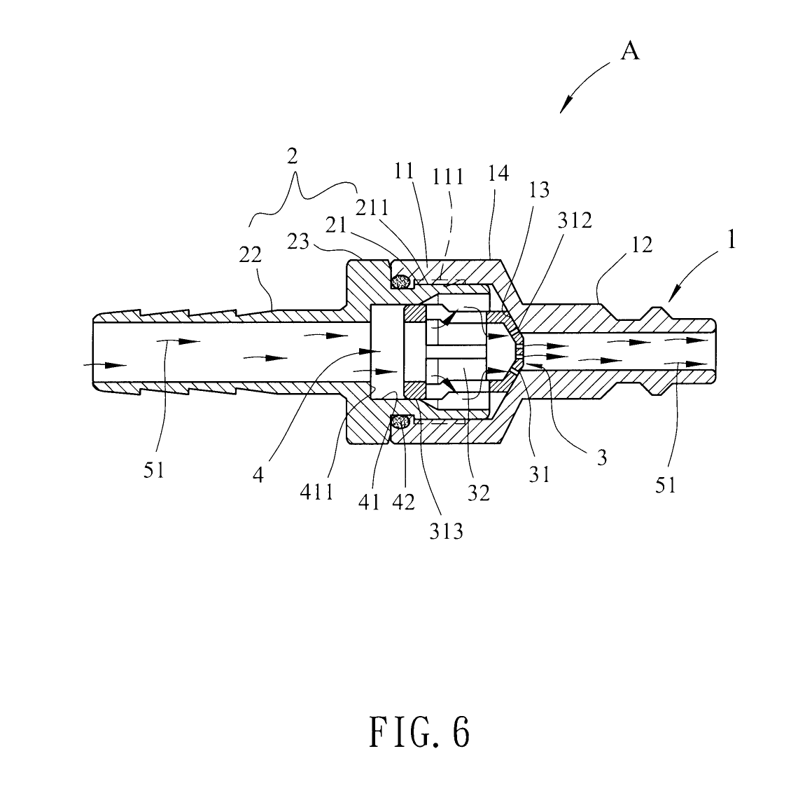

As shown in FIGS. 5 and 6, another embodiment is disclosed and the difference from the first embodiment is that the cone-shaped end 31 of the movable member 3 has multiple release holes 312 defined axially therethrough. The multiple release holes 312 replace the grooves 311. When the cone-shaped end 31 is engaged with the cone-shaped exit 13, the residual pressurized fluid 51 in the hose 52 is released from the release holes 312, so that when the residual pressurized fluid 51 in the hose 52 is released from the male connector “A” slowly.

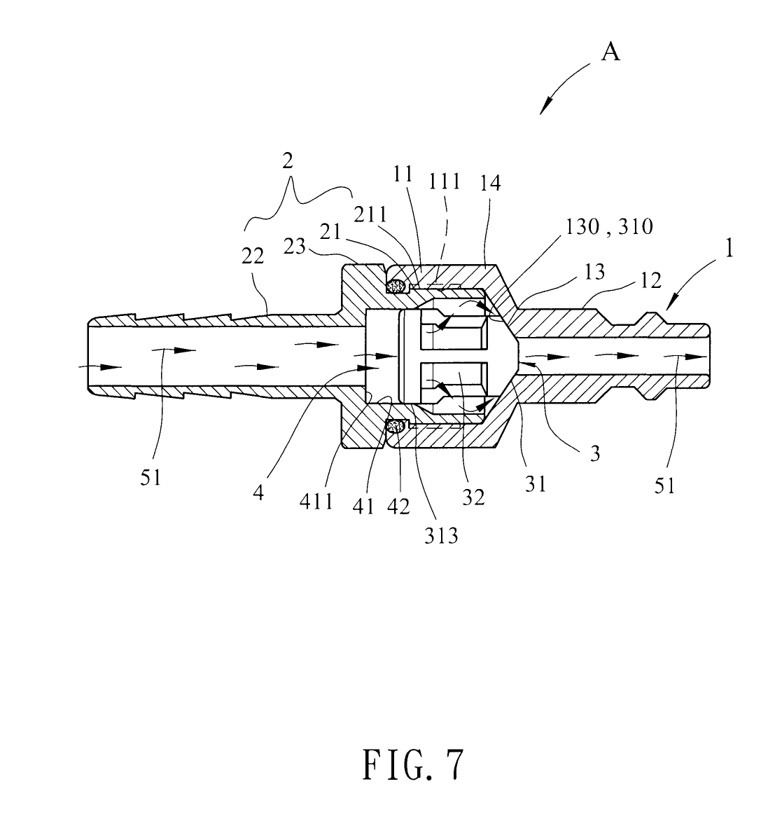

As shown in FIG. 7 shows yet another embodiment of the male connector of the present invention, wherein the difference from the previous two embodiments is that the cone-shaped end 31 of the movable member 3 does not have the grooves 311 or the release holes 312, when the cone-shaped end 31 is engaged with the cone-shaped exit 13, the surface 310 of cone-shaped end 31 is not completely matched with the inner surface 130 of the cone-shaped exit 13. There are multiple gaps formed between the surface 310 of cone-shaped end 31 and the inner surface 130 of the cone-shaped exit 13, the residual pressurized fluid 51 in the hose 52 is released from the male connector “A” via the gaps. However, this embodiment requires a certain period of time to completely release the residual pressurized fluid 51 in the hose 52.

While we have shown and described the embodiment in accordance with the present invention, it should be clear to those skilled in the art that further embodiments may be made without departing from the scope of the present invention.

What is claimed is:

1. A male connector comprising:
a connecting member being a tubular member and having a first connecting portion and a first connecting end respectively located on two ends thereof, an outer diameter of the first connection portion being larger than that of the first connecting end, the connecting member with the first connecting portion and the first connecting end being made integrally and forming multiple radial sections, a cone-shaped exist defined in the connecting member;
a pipe connector being a tubular member and having a second connecting portion and a second connecting end located on two ends thereof, an outer diameter of the second connection portion being larger than that of the second connecting end, the pipe connector with the second connecting portion and the second connecting end being made integrally and forming multiple radial sections, and
a movable member being a hollow member and having a cone-shaped end at a first end thereof, multiple openings defined through a wall of the movable member, the movable member movably located in a space which is formed between the connecting member and the pipe connector, the cone-shaped end sealing the cone-shaped exit of the connecting member.

2. The male connector as claimed in claim 1, wherein the cone-shaped end of the movable member has multiple grooves defined in an outer surface thereof.

3. The male connector as claimed in claim 1, wherein the cone-shaped end of the movable member has multiple release holes defined axially therethrough.

4. The male connector as claimed in claim 1, wherein the movable member has four openings defined through the wall thereof.

5. The male connector as claimed in claim I, wherein the movable member has a travelling end at a second end thereof, a travelling passage is defined between the connecting member and the pipe connector, the travelling passage communicates with the space, the travelling end is movable in the travelling passage, a length of the travelling end is one third of a length of the movable member.

6. The male connector as claimed in claim 5, wherein an outer diameter of the travelling end is larger than an outer diameter of the movable member.

7. The male connector as claimed in claim 5, wherein the length of the movable member is longer than a length from the cone-shaped exit to an entrance of the travelling passage, and shorter than a length of the space.

8. The male connector as claimed in claim 5, wherein a first hexagonal portion is located between the first connecting portion and the first connecting end, a second hexagonal portion is located between the second connecting portion and the second connecting end.

9. The male connector as claimed in claim 5, wherein the first connecting portion has inner threads and the second connecting portion has outer threads.

10. The male connector as claimed in claim 5, wherein a seal ring is located between the connecting member and the pipe connector.
